(19) United States
(12) Patent Application Publication
(10) Pub. No.: US 2016/0375879 A1
(43) Pub. Date: Dec. 29, 2016

(54) METHOD AND DEVICE FOR OPERATING A MOTOR VEHICLE

(71) Applicant: Robert Bosch GmbH, Stuttgart (DE)

(72) Inventor: Martin Lemperle, llsfeld (DE)

(21) Appl. No.: 15/190,667

(22) Filed: Jun. 23, 2016

(30) Foreign Application Priority Data
Jun. 24, 2015 (DE) 102015211647.6

(51) Int. Cl. B60T 8/17; F16H 63/40

(52) U.S. Cl. CPC B60T 8/17; F16H 63/40; B60T 2260/04

(57) ABSTRACT

A method for operating a motor vehicle which includes a brake system having an actuatable brake pedal and a controllable power brake unit, and an automatic transmission having a gearshift lever that includes a plurality of shifting positions for selecting different gears of the automatic transmission. The power brake unit is triggered to set a braking force as a function of at least one change of shifting position of the gearshift lever.

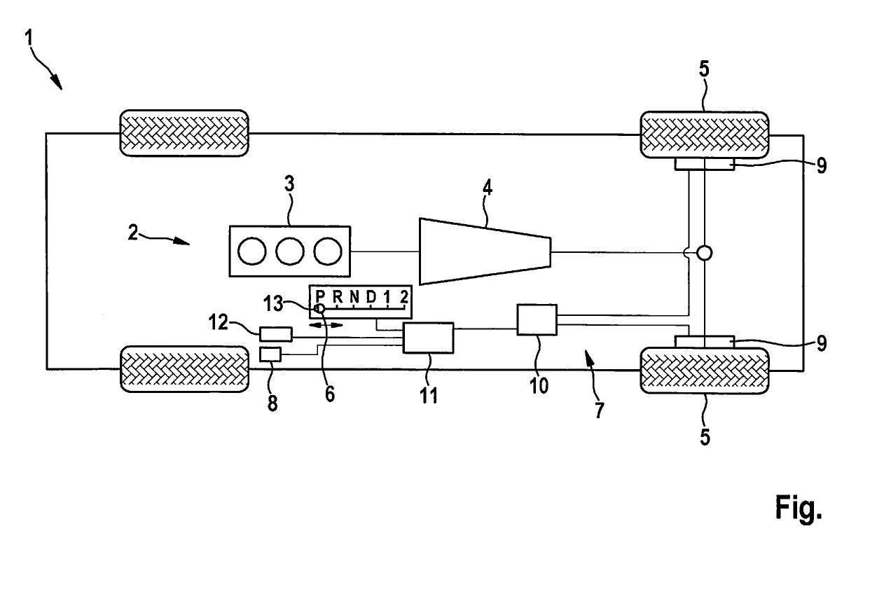

### CROSS REFERENCE

The present application claims the benefit under 35 U.S.C. §119 of German Patent Application No. DE 102015211647.6 filed on Jun. 24, 2015, which is expressly incorporated herein by reference in its entirety.

### FIELD

The present invention relates to a method for operating a motor vehicle, which includes a brake system having an actuatable brake pedal and a controllable power brake unit, and an automatic transmission having a gearshift lever that includes a plurality of shifting positions for selecting different stages of the automatic transmission.

The present invention further relates to a device for operating such a motor vehicle.

### BACKGROUND INFORMATION

In order to prevent a motor vehicle from immediately moving off when a driver moves the gearshift lever from a parking position into a driving position, a change of shifting position is only permitted when the driver simultaneously actuates the brake pedal, in order to ensure that the vehicle does not move off in an undesirable manner.

### SUMMARY

An example method in accordance with the present invention may have the advantage that an actuation of the brake pedal by the driver is now no longer necessary. Instead, the motor vehicle itself satisfies all of the safety-related starting conditions, which prevent, in particular, the vehicle from moving off in an unwanted manner in response to changing gears by moving the gearshift lever. To this end, the method of the present invention provides for the power brake unit to be triggered to set a braking force as a function of at least one change of shifting position. Power brake units are generally conventional. Electromechanical or electromagnetic power brake units, which are able to set a braking force independently of an actuation of a brake pedal, are increasingly being used. Consequently, such power brake units are controllable, and in particular, independently of an actuation of a brake pedal. The present invention provides for the braking force to be set, when a gear change is made by moving the gearshift lever from a first shifting position into a second shifting position. To that end, the position of the gearshift lever is continuously monitored during operation of the motor vehicle. As soon as it is determined that the gearshift lever is being moved, the braking force is set and the motor vehicle is kept at rest. Depending on the specific embodiment of the automatic transmission and the gearshift lever, the power brake unit may be triggered to set a braking force in response to every change of shifting position or only in response to some of the possible changes of shifting position. Thus, for example, it would be of little practicality to activate the power brake unit when the gearshift lever is moved from a first forward gear into a second forward gear.

It is particularly preferable for the power brake unit to be triggered to set the braking force, when it is known that a change of shifting position will occur. In this manner, the power brake unit is already activated when it is assumed that a change of shifting position will follow, which means that the braking force is already available when the change of shifting position actually takes place.

In particular, it is provided that a change of shifting position soon to be occurring be detected when an actuating element situated at the gearshift lever is actuated. Gearshift levers often include actuating elements, which only allow the shifting position of the gearshift lever to be adjusted when they are actuated, which allows unwanted/unintentional adjustment of the shifting position to be prevented, in particular, during the drive. Consequently, by monitoring the actuating state of the actuating element, it may easily be determined, whether or not a change of shifting position will take place. In this manner, the power brake unit is activated neither continually nor late for setting the braking force.

According to a further refinement of the present invention, it is provided that the power brake unit only be activated when the vehicle is stationary. To that end, the traveling speed of the vehicle is continuously monitored, although this is done in most motor vehicles anyway; thus, only the data of, for example, an engine control unit or the like must be obtained in order to determine the driving state. In order to prevent a braking force from being set while the vehicle is moving, the power brake unit is only activated when the vehicle is determined to be at rest.

In addition, it is preferably provided that the power brake unit be activated only when the gearshift lever is moved from a parking position or neutral position into a driving position. In this manner, it is provided that the braking force be set only when the vehicle is already stationary, as expected, namely, when the gearshift lever is initially in the parking position or in the neutral position. As in the case of conventional automatic transmissions, the drive train is locked when the gearshift lever is in the parking position, and disconnected from a driving machine when it is in the neutral position.

Furthermore, it is preferably provided that the power brake unit be triggered to reduce the braking force, when an accelerator pedal of the motor vehicle is actuated and the gearshift lever is in a driving position. Thus, after a change of shifting position is made, the braking force is reduced as soon as the driver actuates the accelerator pedal. This prevents an instance of locking when acceleration of the motor vehicle is desired.

An example device of the present invention distinguishes itself through a specially adapted control unit that executes the method of the present invention. The above-mentioned advantages become apparent from this. Further features and advantages are apparent from the description above and below.

In the following, the present invention is explained in greater detail in view of the FIGURE.

### BRIEF DESCRIPTION OF THE DRAWING

The FIGURE shows a simplified representation of a motor vehicle.

### DETAILED DESCRIPTION OF EXAMPLE EMBODIMENTS

In a simplified plan view, the FIGURE shows a motor vehicle 1, which has a drive train 2 that includes a driving machine 3 and an automatic transmission 4; the automatic transmission 4 being mechanically linked, on its output side, to driven wheels 5 of the motor vehicle. Automatic transmission 4 has a conventional torque or a dual clutch system and is coupled, at its input, to driving machine 3, which, in the present exemplary embodiment, takes the form of an internal combustion engine.

Automatic transmission 4 is also attached to a device 5 for selecting a gear. Device 5 includes a gearshift lever 6 able to assume a plurality of shifting positions P, R, N, D, 1 and 2, which correspond to different gears that may also be driving programs; in the present exemplary embodiment, the different gears or shifting positions of gearshift lever 6 being situated one behind the other. As in the case of conventional devices, it is provided that in shifting position P (parking position), automatic transmission 4 be switched into a parking mode, in which it locks driven wheels 5. In shifting position R, automatic transmission 4 is triggered to shift into a reverse gear. In shifting position N (neutral position), automatic transmission 4 is shifted into a neutral mode, in which, in particular, the connection to drive machine 3 is broken, so that driven wheels 5 may rotate freely. In shifting position “1,” a low gear having a high gear ratio is engaged, and in shifting position “2,” a higher gear of automatic transmission 4 is engaged, the higher gear having a lower gear ratio.

In addition, motor vehicle 1 includes a brake system 7, which has a brake pedal 8 able to be actuated by the driver of motor vehicle 1, as well as a plurality of wheel brakes 9. In this context, each of driven wheels 5 is assigned one of wheel brakes 9. The remaining wheels of motor vehicle 1 may also be assigned corresponding wheel brakes. Brake system 7 takes the form of a hydraulic brake system and also includes a power brake unit 10, which takes the form of an electromotive, electromechanical, and/or electromagnetic power brake unit. By activating power brake unit 10, a desired braking force may be set at wheel brakes 9, if necessary, independently of an actuatable brake pedal 8. A control unit 11 monitors the shifting position of gearshift lever 6, as well as the actuating state of brake pedal 8 and of an accelerator pedal 12 of motor vehicle 1.

If control unit 11 determines that a change of shifting position of device 5 from a position P or N to one of gears R, D, 1 or 2 is occurring, then control unit 11 triggers power brake unit 10 to set a braking force at wheel brakes 9 when motor vehicle 1 is stationary. In this manner, when the driver moves gearshift lever 6 into a gear, motor vehicle 1 does not move off, but is held in the current position. Gearshift lever 6 includes, in particular, an actuating element 13, which the driver must actuate in order to move gearshift lever 6 from one shifting position into another shifting position. Control unit 11 also monitors the actuating state of actuating element 13. If gearshift lever 6 is in one of positions P or N and the driver actuates actuating element 13, then control unit 11 activates power brake unit 10, so that its braking force is generated at wheel brakes 9, which motor vehicle 1 is locking or holding in place, although a torque is already being transmitted to driven wheels 5 by automatic transmission 4. By taking into account the actuating state of actuating element 13, a change of shifting position is predicted, so that the braking force is already set when the driver actually actuates or moves gearshift lever 6.

What is claimed is:

1. A method for operating a motor vehicle which includes a brake system having a actuatable brake pedal, a controllable power brake unit, and an automatic transmission having a gearshift lever that includes a plurality of shifting positions for selecting different gears of the automatic transmission, the method comprising:
triggering the power brake unit to set a braking force as a function of at least one change of shifting position of the gearshift lever.

2. The method as recited in claim 1, wherein the power brake unit is activated when it is determined that a change of shifting position will occur.

3. The method as recited in claim 1, wherein the gearshift lever includes an actuating element which permits the at least one change of shifting position only in the actuated state, and a change of shifting position is detected, when the actuating element is actuated.

4. The method as recited in claim 1, wherein the power brake unit is activated when the at gearshift lever is shifted only when the motor vehicle is at rest.

5. The method as recited in claim 1, wherein the power brake unit is activated when the gear lever is shifted when the gearshift lever only when the gearshift lever is moved from a parking position or neutral position into a driving position.

6. The method as recited in claim 1, wherein the power brake unit is triggered to reduce the braking force, when an accelerator pedal of the motor vehicle is actuated and the gearshift lever is in a driving position.

7. A device for operating a motor vehicle which includes a brake system having an actuatable brake pedal, a controllable power brake unit, and an automatic transmission having a gearshift lever that includes a plurality of shift positions for selecting different gears of the automatic transmission, the device comprising:
a control unit adapted to trigger the power brake unit to set a braking force as a function of at least one change of shifting position of the gearshift lever.
